(19) United States
(12) Patent Application Publication
(10) Pub. No.: US 2007/0150281 A1
(43) Pub. Date: Jun. 28, 2007

(54) Method and system for utilizing emotion to search content

(76) Inventor: Todd Miles Hoff, Los Gatos, CA (US)

Correspondence Address: BRUCE E. HAYDEN, P.C., P.O. BOX 205, DILLION, CO, 80435-0205, US

(21) Appl. No.: 11/317,472

(22) Filed: Dec. 22, 2005

(51) Int. Cl. G10L 21/00

(52) U.S. Cl. 704/270

(57) ABSTRACT

Emotions are utilized as the basis for categorizing and searching content, including creating reviews, characterizing existing Internet items through automated and manual analysis, creating user profiles for behavioral targeting applications, matching consumers to items, searching for items, and recommending items. Content is first classified or characterized by emotion. A person's emotional needs are then determined. These emotional needs are then utilized to search for and provide content to that person.

### FIELD OF THE INVENTION

The present invention generally relates to searching content and, more specifically, to utilizing desired emotional state to enhance searching content such as reviews.

### BACKGROUND OF THE INVENTION

Currently, computer systems provide very sophisticated search capabilities. The search engine provided by Google Inc., for example, is utilized by millions of people every day to find content on the Internet. Both Google and Microsoft Corporation are moving this sort of search engine capabilities to the desktop in order to provide users there the type of sophisticated searching available today on the Internet. Yahoo, Inc. has recently announced that it is implementing behavioral targeting where ads are targeted to consumers based on their web browsing behavior. On a somewhat more personal level, review sites provide reviews of almost anything one could want, including reviews of products, services, ideas, web pages, experiences, music, vacations, etc.

But the current search engine and review engine technology tend to be based on searching for concrete terms. Review sites tend to be feature based—searching is based on a list of attributes presented to a user. The users are then expected to make a selection based on these attributes. In all of these cases though, the element missing in searching and reviewing is the desired emotional state of the searcher.

There are numerous methods of mechanically or automatically determining or identifying emotions, including: U.S. Pat. No. 4,041,617 issued Jul. 26, 1976 to Hollander titled “Apparatus and Method for Indication and Measurement of Simulated Emotional Levels”; U.S. Pat. No. 6,006,188 issued Dec. 21, 1999 to Bogdashevsky, et al. titled “Speech Signal Processing for Determining Psychological or Physiological Characteristics Using a Knowledge Base”; U.S. Pat. No. 6,151,571 issued Nov. 21, 2000 to Pertrushin titled “System, Method and Article of Manufacture for Detecting Emotion In Voice Signals Through Analysis of a Plurality of Voice Signal Parameters”; U.S. Pat. No. 6,275,806 issued Aug. 14, 2001 to Pertrushin titled “System Method and Article of Manufacture for Detecting Emotion In Voice Signals by Utilizing Statistics for Voice Signal Parameters”; U.S. Pat. No. 6,292,688 issued Sep. 18, 2001 to Patton titled “Method and Apparatus for Analyzing Neurological Response to Emotion-Inducing Stimuli”; U.S. Pat. No. 6,480,826 issued Nov. 12, 2002 to Pertrushin titled “System and Method for a Telephonic Emotion Detection that Provides Operator Feedback”; U.S. Pat. No. 6,622,140 issued Sep. 16, 2003 to Kantrowitz titled “Method and Apparatus for Analyzing Affect and Emotion In Text”; U.S. Patent Application Number 20020163500 filed Nov. 7, 2002 by Steven B. Griffith titled “Communication Analyzing System”; U.S. Patent Application Number 20030033145 filed Feb. 13, 2003 by Valery A. Petrushin titled “System, Method, and Article of Manufacture for Detecting Emotion In Voice Signals by Utilizing Statistics for Voice Signal Parameters”; U.S. Patent Application Number 20030139654 filed Jul. 24, 2003 by Kyung-Hwan Kim, et al. titled “System and Method for Recognizing User's Emotional State Using Short-Time Monitoring of Physiological Signals”; U.S. Patent Application Number 20030182123 filed Sep. 25, 2003 by Shunji Mitsuyoshi titled “Emotion Recognizing Method, Sensibility Creating Method, Device, and Software”; and U.S. Patent Application Number 20050114142 filed May 26, 2005 by Masamichi Asukai, et al. titled “Emotion Calculating Apparatus and Method and Mobile Communication Apparatus”.

Emotions have been utilized to enhance voice synthesis, such as in: U.S. Pat. No. 5,305,423 issued Apr. 19, 1994 to Clynes titled “Computerized System for Producing Sentic Cycles and for Generating and Communicating Emotions”; U.S. Pat. No. 5,860,064 issued Jan. 12, 1999 to Henton titled “Method and Apparatus for Automatic Generation of Vocal Emotion in a Synthetic Text-To-Speech System”; U.S. Pat. No. 5,987,415 issued Nov. 16, 1999 to Breese, et al. titled “Modeling a User's Emotion and Personality in a Computer User Interface”; U.S. Pat. No. 6,185,534 issued Feb. 6, 2001 to Breese, et al. titled “Modeling Emotion and Personality In a Computer User Interface”; U.S. Pat. No. 6,212,502 issued Apr. 3, 2001 to Ball, et al. titled “Modeling and Projecting Emotion and Personality from a Computer User Interface”; U.S. Pat. No. 6,721,734 issued Apr. 13, 2004 to Subasic, et al. titled “Method and Apparatus for Information Management Using Fuzzy Typing”; U.S. Pat. No. 6,826,530 issued Nov. 30, 2004 to Kasai, et al. titled “Speech Synthesis for Tasks with Word and Prosody Dictionaries”; and U.S. Patent Application Number 20030067486 filed Apr. 10, 2003 by Mi-Hee Lee, et al. titled “Apparatus and Method for Synthesizing Emotions Based on the Human Nervous System”.

One utilization of emotions is disclosed in U.S. Pat. No. 6,585,521 issued Jul. 1, 2003 to Obrador titled “Video Indexing Based on Viewers' Behavior and Emotion Feedback”. In this patent, short video clips are associated with specific emotions. Later, someone can view clips associated with a given emotion. Another utilization of emotions is disclosed in U.S. Patent Application Number 20050223237 filed Oct. 6, 2005 by Antonio Barletta, et al. titled “Emotion Controlled System for Processing Multimedia Data” which describes changing multimedia output based upon perceived emotions of the viewer.

### BRIEF SUMMARY OF THE INVENTION

Emotions are utilized as the basis for categorizing and searching content, including creating reviews, characterizing existing Internet items through automated and manual analysis, creating user profiles for behavioral targeting applications, matching consumers to items, searching for items, and recommending items. Content is first classified or characterized by emotion. A person's emotional needs are then determined. These emotional needs are then utilized to search for and provide content to that person.

### BRIEF DESCRIPTION OF THE DRAWINGS

FIG. 1 is a flowchart illustrating operation of a preferred embodiment of the present invention; and

FIG. 2 is a block diagram illustrating a General Purpose Computer.

### DETAILED DESCRIPTION OF THE INVENTION

Some of the objects of the present invention are to use emotions as the basis for creating reviews, characterizing existing Internet items through automated and manual analysis, creating user profiles for behavioral targeting applications matching consumers to items, searching for items, and recommending items. The use of emotion for these purposes on the Internet is a novel application and is superior to current approaches because emotion is more direct and accurate basis for capturing human judgment, matching preferences, and creating satisfactory outcomes.

An emotion is a felt experience. Emotions go beyond thought because humans don't think emotions, rather they feel emotions. An emotion is unarguably true from the perspective of the person experiencing the emotion. As humans, we have the emotions we have and there is no rationalizing or arguing our emotional responses away. Nearly everything people interact with causes in them an emotional response. Emotions are potentially the most accurate source of our true evaluation of an item. People may not be able to verbalize our response to an item, yet they will still have an emotional reaction. Emotions reveal their unspoken concerns. Taken together all these qualities of emotion make emotion the bedrock on which to create the invention described below.

Traditionally, emotions have been seen as an obstacle to good decision making. Good decision are thought not to be based on emotional responses. Good decisions are said to based on rational objective calculation.

But that is not how people make decisions in real life. People make decisions based on emotional reasons. It makes sense to drop largely mathematical approaches and go directly to the heart of the matter: emotions.

Does it matter if product is 10% cheaper if someone won't like it emotionally? Should s/he pick a product because others say it is a better value even though s/he may come to regret that decision for you entire life? No. That's why emotions are critical in decision making, but the problem is that emotions are currently not employed in, for example, Internet systems.

Most review sites are feature based. Users are presented with lists of attributes and are then expected make a selection based on a comparison of attributes. One problem with that approach is that data don't make decisions, people do. Acquiring more data often tends to make people skip making decisions and/or the decision making progress takes much longer because of the data.

“Recommender” systems traditionally have not taken into account the target emotional state a person has when looking for an item. Recommender systems are usually based on a numeric rating system where people are asked to rate an item on a scale. Then the Recommender system will find people who have made similar product evaluations and then recommend a product a person will probably like based on those similarities.

The approach described in this invention preferably eliminates the use of rating systems and the use of feature comparison approaches in favor of using emotion as the basis for the invention disclosed below.

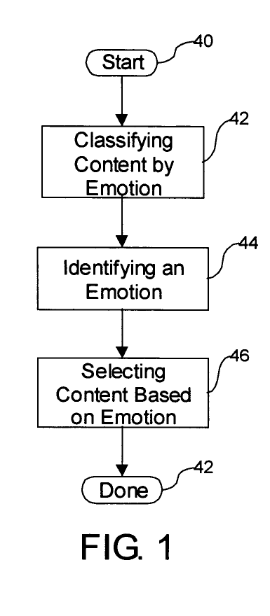

FIG. 1 is a flowchart illustrating operation of a preferred embodiment of the present invention. Starting, step 40, content is classified or characterized by emotion, step 42. The content may be, for example, reviews such as products, services, ideas, web pages, experiences, music, or vacations. It may also be other types of web pages, or people or organizations for target marketing. There are numerous different methods of classifying or characterizing content by emotion, many of which are disclosed above. For example, a page may be evaluated by the mechanisms disclosed in U.S. Pat. No. 6,622,140 issued Sep. 16, 2003 to Kantrowitz titled “Method and Apparatus for Analyzing Affect and Emotion In Text”. One alternative is to have reviewers manually classify or characterize content by emotion. Thus, for example, a reviewer might classify a page as “regretted”. Also, this may be done through voting, similar to that which is currently done by Amazon.com with its ratings for books, music, etc. Amazon lets those visiting its web pages for certain products vote as to the worth of those products on a five star basis. The cumulative vote is displayed to prospective purchasers. In this invention, the voting would be extended to allow identification of different emotions.

In a preferred embodiment, when creating a review a user is asked for emotional evaluation of the item under review. The emotion evaluation is taken in such a way that the user is not asked to reflect on the meaning of their selections. They are to give their emotional response to item as quickly as possible.

An actual or desired emotion of a person is then identified, step 44. The system is guided by that person's stated emotional goal state, their inferred emotional profile, and their declared emotional profile. For example, a user, because of his personality, may wish to avoid regret above all. The system makes use of a person's desire to avoid regret while performing system operations. The system can determine a person's desire to avoid regret through various means. For example, it can utilize explicit questionnaires. It can also infer that person's desires from his interactions with the system.

This can be done through querying the person or through machine based means, such as were discussed above. For example, the person may be queried as to his preferred emotion, such as “avoiding regret”. Alternatively, an emotion may be identified through voice analysis as disclosed in U.S. Pat. No 6,151,571 issued Nov. 21, 2000 to Pertrushin titled “System, Method and Article of Manufacture for Detecting Emotion In Voice Signals Through Analysis of a Plurality of Voice Signal Parameters”.

Then, the emotion or emotions identified in step 44 are utilized to select content, step 46. Typically, emotion will be one of a plurality of parameters utilized in the selection process. Thus, for example, if the person elected avoiding “regret” and “Country Western” music, reviews for that type of music could be provided him that minimized regret for those who have listened to the music before.

In a preferred embodiment, a user is asked for their desired emotional state from the item. For example, a user may wish to “avoid regret”. In that case the system will find items that are likely to minimize the users chance of feeling regret if they should choose to use the selected item. Alternatively, the target emotional state can be inferred by, for example, software, as described above.

A generalized identification function could be thought of as:
W=f(E(G), E(I), E(A), E(C))
Where:
“W” are the results produced by the system for a user. It could be a set of reviews, web pages, recommendations, customer target segments, or any other operation “f”.
“f” is the function performed to return the results. The options are: item reviews, characterizing items through automated and manual analysis, creating user profiles for targeting applications, matching consumers to items, searching for items, and recommending items.
“E” is a function for producing, through a manual or automated process, an emotional characterization.
“G” is the user's desired emotional outcome from the function performed. It is used by “f” to produce “W” from “I”, “A”, and “C”.
“I” is the item, which is anything characterizable using emotions.
“A” is the actors, the people and other systems involved in “f”.
“C” is the context, the surrounding environment for Items and Actors. It would include items like current events; a user's mental, physical, and emotional state; holidays; economic news; anything that could influences a user's emotional state and response.

After selecting content based on emotion and providing it to the person, step 46, the method is complete, step 48.

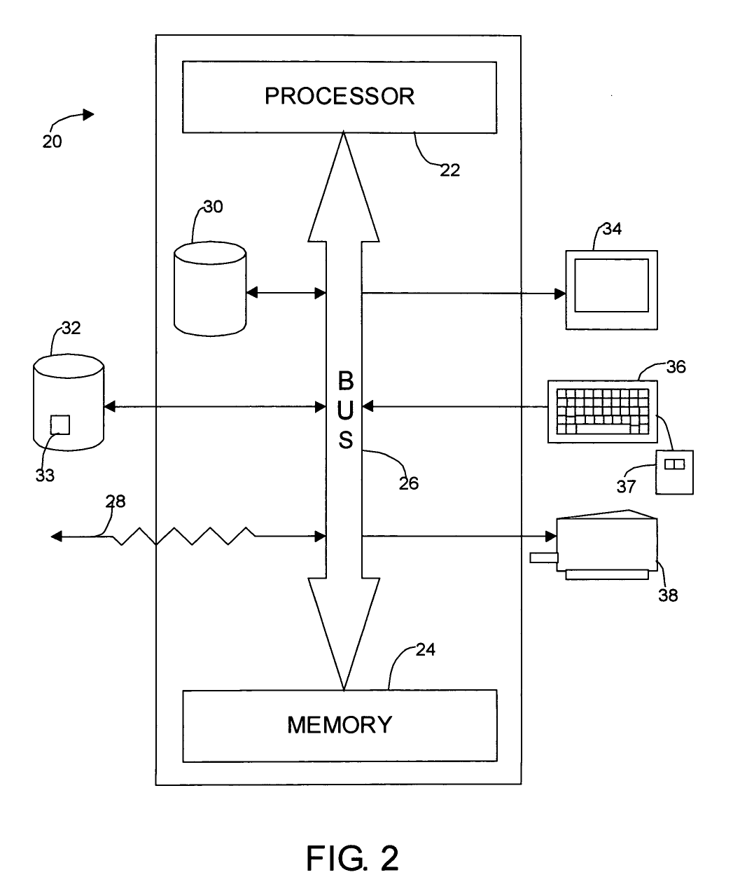

FIG. 2 is a block diagram illustrating a General Purpose Computer 20. The General Purpose Computer 20 has a Computer Processor 22, and Memory 24, connected by a Bus 26. Memory 24 is a relatively high speed machine readable medium and includes Volatile Memories such as DRAM, and SRAM, and Non-Volatile Memories such as, ROM, FLASH, EPROM, EEPROM, and bubble memory. Also connected to the Bus are Secondary Storage 30, External Storage 32, output devices such as a monitor 34, input devices such as a keyboard 36 with a mouse 37, and printers 38. Secondary Storage 30 includes machine-readable media such as hard disk drives, magnetic drum, and bubble memory. External Storage 32 includes machine-readable media such as floppy disks, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such test programs, operating systems, and user programs can be stored in a Computer Software Storage Medium, such as memory 24, Secondary Storage 30, and External Storage 32. Executable versions of computer software 33, such as software for implementing this invention can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

Those skilled in the art will recognize that modifications and variations can be made without departing from the spirit of the invention. Therefore, it is intended that this invention encompass all such variations and modifications as fall within the scope of the appended claims.

What is claimed is:

1. A method for selecting content based on emotion comprising:
identifying an emotion from an actor; and
selecting a one of a plurality of content based on the emotion as a selected content.

2. The method in claim 1 wherein:
the identifying the emotion comprises:
querying the actor for the emotion.

3. The method in claim 1 wherein:
the identifying the emotion comprises:
utilizing a psychometric means to measure a physical characteristic of a person in order to infer the emotion.

4. The method in claim 1 wherein:
the identifying the emotion comprises:
analyzing electronic actions of the actor in order to infer the emotion.

5. The method in claim 1 which further comprises:
classifying the plurality of content by associating at least one emotion with at least one of the plurality of content.

6. The method in claim 1 wherein:
the selecting the one of the plurality of content utilizes behavioral targeting.

7. The method in claim 1 which further comprises:
selecting a second one of the plurality of content based on the emotion as a second selected content.

8. The method in claim 1 wherein:
each of the plurality of content comprises a review; and
the selected content is a selected review.

9. The method in claim 1 wherein:
each of the plurality of content comprises an advertisement; and
the method further comprises:
providing the selected content to the actor.

10. The method in claim 1 wherein:
each of the plurality of content comprises a document; and
the method further comprises:
associating an emotion with at least one of the plurality of content; and
ranking at least one of the plurality of content based on the emotion associated with the one of the plurality of content.

11. A system for selecting content based on emotion comprising:
a memory containing computer instructions for identifying an emotion from an actor; and
a memory containing computer instructions for selecting a one of a plurality of content based on the emotion as a selected content.

12. The system in claim 11 wherein:
the computer instructions for identifying the emotion comprise:
computer instructions for accepting a result of querying the actor for the emotion.

13. The system in claim 11 wherein:
the computer instructions for identifying the emotion comprise:
computer instructions for accepting a result of a psychometric means to measure a physical characteristic of a person in order to infer the emotion.

14. The system in claim 11 wherein:
the computer instructions for identifying the emotion comprise:
computer instructions for analyzing electronic actions of a person in order to infer the emotion.

15. The system in claim 11 which further comprises:
a memory containing computer instructions for classifying the plurality of content by associating at least one emotion with at least one of the plurality of content.

16. The system in claim 11 wherein:
the computer instructions for selecting the one of the plurality of content implements behavioral targeting.

17. The system in claim 11 which further comprises:
a memory containing computer instructions for selecting a second one of the plurality of content based on the emotion as a second selected content.

18. The system in claim 11 wherein:
each of the plurality of content comprises an advertisement; and
the system further comprises:
a memory containing computer instructions for providing the selected content to the actor.

19. The system in claim 11 wherein:
each of the plurality of content comprises a document; and
the system further comprises:
a memory containing computer instructions for associating an emotion with at least one of the plurality of content; and
a memory containing computer instructions for ranking at least one of the plurality of content based on the emotion associated with the one of the plurality of content.

20. A system for selecting content based on emotion comprising:
a means for identifying an emotion from an actor; and
a means for selecting a one of a plurality of content based on the emotion as a selected content.
